(19) United States
(12) Patent Application Publication
(10) Pub. No.: US 2006/0239759 A1
(43) Pub. Date: Oct. 26, 2006

(54) Illuminated writing instrument

(76) Inventor: Dan L. Dietz, Houston, TX (US)

Correspondence Address: DARCELL WALKER, 8107 CARVEL LANE, HOUSTON, TX, 77036, US

(21) Appl. No.: 11/112,260

(22) Filed: Apr. 23, 2005

(51) Int. Cl. A46B 5/02; B43K 29/00

(52) U.S. Cl. 401/195; 401/6

(57) ABSTRACT

An improved illuminated writing instrument comprises a writing element, a lighting element and an attaching element. The writing and lighting elements are secured to each other via the attaching element. The writing and lighting are secured to each other through openings in the attaching element. The attaching element has an exterior surface formed of elastic grippers that provide increased stability between the user and the writing instrument. The attaching element also has the capability to alter its shape in response to pressure from the user's fingers. This capability to alter the shape of the attaching element enables the user to easily and comfortably hold the writing instrument.

### FIELD OF THE INVENTION

The present invention relates to an illuminated writing instrument and in particular to an improved illuminated writing instrument comprising an ergonomically designed attaching element to facilitate securing the writing instrument and the illuminating instrument into one functional device. The attaching element comprises a material that attaches the writing and illuminating devices such that the user can more easily and comfortably hold the combination writing and illuminating instrument during a writing session.

### BACKGROUND OF THE INVENTION

Written communications have been a primary means of communication dating back to the medieval period. As early as the 4^{th} century, people used crude writing instruments to communicate information. These instruments consisted of hollow straws or reeds that supported a short column of liquid. During the fifth century, people began to make pens formed from wing feathers. Currently, the writing pen has evolved into a variety writing instruments, which include: the ballpoint pen, the fountain pen, the soft-tip pen lettering pin and the technical pin. Today, pens rank among the most widely used writing instrument.

One concept of the writing instrument is to attach a light such as a flashlight to the instrument. This combination enables the user to be able to see the surface on which they are writing when the surrounding light is inadequate. For many years, there have been several versions of the illuminated writing instrument.

U.S. Pat. No. 1,516,647 describes a pencil illuminating light. This device comprised a writing pencil having a light contained in a light receptacle that was coupled to it the writing pencil. A wire connected the receptacle to a portable power source.

U.S. Pat. No. 1,615,740 describes a writing instrument and completely separate lighting instrument joined by clips that extended from the lighting instrument. These clips were able to engage the writing instrument and secure the lighting instrument to the writing instrument.

U.S. Pat. No. 2,964,614 describes a ballpoint pen with a light bulb disposed adjacent the ballpoint. The pen and light bulb are encased within one housing. In addition, the act of depressing the end of the pen to shift the pen into the writing position would also activate the source of light. Shifting the pen back to a closed position would deactivate the light source. With this device, the user could only write with the light on.

U.S. Pat. No. 3,879,859 describes an apparatus for visual instruction having a light and a means to write on surface such as a screen. The application of this device was for classroom and other teaching presentations.

U.S. Application 20020044442 describes a writing apparatus having permanently attached writing and lighting instruments. Each instrument would be activated separately.

While there are many devices designed to provide a light source for a writing instrument when the surrounding light is inadequate, each of these devices has a fixed configuration and other limitations. There remains a need for an illuminated writing instrument that can be reconfigured based on the user's desire for additional lighting at the writing surface.

### SUMMARY OF THE INVENTION

It is an objective of the present invention to provide an illuminated writing instrument that can be reconfigured to include a lighting source when desired by the user.

It is second objective of the present invention to provide an ergonomically designed attaching element that can securely hold both a writing instrument and an illuminating instrument.

It is a third objective of the present invention to provide an attaching element that has supple and elastic characteristics such that the surface of the material will contour in response to the pressure of the user's fingers, thereby providing a cushioned surface for the fingers and a better handling of the writing instrument.

It is fourth objective of the present invention to provide an illuminated writing instrument that will produce a custom fit between the attaching element and the user's fingers.

The present invention provides an improved illuminated writing instrument and system. The invention comprises an elongated writing instrument such as a pencil or pen. The invention further comprises an elongated lighting source that attaches to the writing instrument. A supple elastic housing attaches the writing instrument and lighting source to form one instrument. The attaching element contains two openings that extend through the material. The writing instrument is inserted into one of the openings and the light source is inserted into the other opening. The elastic character of the material enables the material to adhere to the inserted objects and adequately secure the objects. Both the writing and light instruments extend through the attaching element such that the attaching element does not interfere with the writing and lighting operations.

Although the attaching element material secures the writing and lighting instruments, these instruments can be repeatedly withdrawn from the housing without damaging material ability to secure the inserted devices.

### DESCRIPTION OF THE DRAWING

FIG. 1 shows a front, top, and side view of the writing apparatus of the present invention.

FIG. 2 shows a side cross-section view of the illuminated writing apparatus of the present invention.

FIG. 3 shows a top cross-section view of the attaching element of the present invention.

FIG. 4 shows an alternate design for the attaching element having a more rigid material surrounding the openings in the attaching element.

FIG. 5 shows an alternate embodiment for the attaching element having ridges in the opening to further secure the writing and lighting instruments in the attaching element.

### DETAILED DESCRIPTION OF THE INVENTION

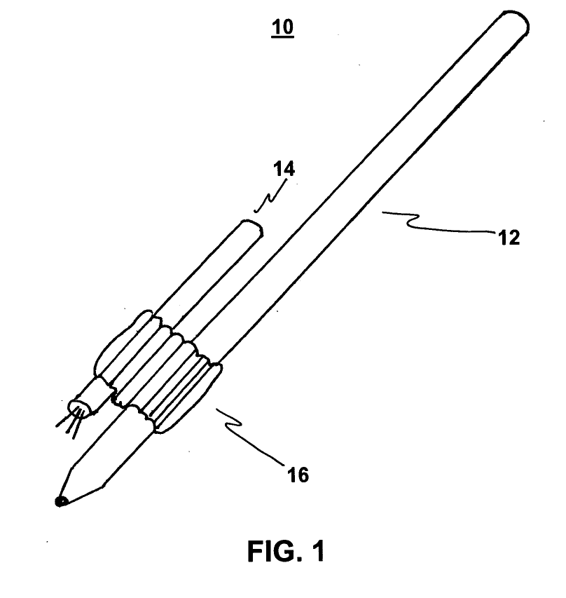

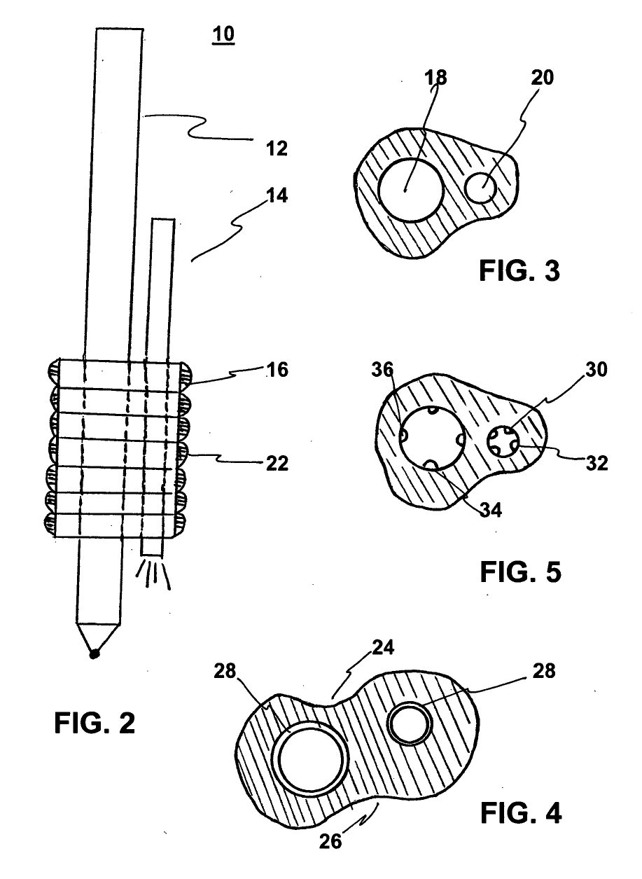

FIG. 1 shows a top, front and side view of the illuminated writing instrument of the present invention. The instrument 10 contains a writing element 12, a lighting element 14 and an attaching element 16. The writing element 12 can be any conventional writing instrument including pencils or pens. Referring to FIG. 2, the writing instrument should have a generally elongated shape. The preferred surface of this element should be rounded smooth, which would result in a circular surface contour. However, other writing instrument surfaces will work within the design of this invention. As with the writing instrument, the light instrument 14 should also be have an elongated shape. This instrument also has a generally rounded surface. The power source for the lighting element is usually contained within the lighting element. In some instances, such as with an optic cable lighting element, the power source may be external.

FIG. 3 illustrates a more detailed view of the attaching element 16. This housing can be made of a supple elastic material. One such material could be rubber. The housing has two openings 18 and 20. These openings can be circular, another general shape or can have no general shape. Regardless of the shape, the openings are designed such that the elastic material adheres to the surface of the inserted instruments. The openings 18 and 20 can be the same size or different sizes. Generally, the writing element is larger in diameter than the lighting element. In FIG. 3, opening 18 is larger than opening 20. Opening 18 would contain the writing element 12 and opening 20 would contain the lighting element 14.

As shown in FIG. 2, the outer surface of the attaching element 16 has ridges 22. These ridges provide a surface that interacts with the fingers of the user to provide a more stable grip of the instrument by the user. In addition to this enhanced grip, the shape of the attaching element can also facilitate an enhanced grip by the user.

In the present invention, the user will hold the attaching element during the writing activity. This practice is different from conventional illuminated writing devices, which have the lighting source extended away from the writing source. With the attaching component being larger than a typical writing instrument, the user will exert more strength/pressure on the device to maintain the proper amount of control of the writing device. This additional strength will also require the user to use more finger dexterity to control the device.

The supple and elastic characteristics of the attaching element enable the attaching element to conform or adapt in shape to the positions of the user's fingers. The initial contour of the attaching element can be uniform or it can have a slightly contoured surface. In FIG. 2, the contour is based on the fact that one instrument may be larger than the other instrument and will require a larger opening. In addition, a contoured shape having slightly depressed areas 24 and 26 shown in FIG. 4 can easily accommodates the positions of the fingers of the user of the writing instrument. Even with the contoured surface, the material of the attaching element can still further conform to the position of the user's fingers and provide the desired cushion for the fingers.

The material of the attaching element would respond to the pressure exerted on the materials by the user. The places of the attaching element surface receiving the pressure from the user's fingers will become depressed in response to receiving this pressure. As a result, the shape of the attaching element becomes deformed until the pressure of the fingers is no longer there. At this point, the attaching element could reassume its original shape. This characteristic is not present in many of the conventional writing devices that have some sort of material surrounding the device to provide for a better grip and serve as a cushion for the user's fingers. In the current devices, this material has a set shape and does not deviate from its initial shape. The supple and elastic materials of the attaching element also provide a cushion for the user's fingers and facilitates an ergonomic posture for the fingers.

The attaching element can also be of a composite material 28 as shown in FIG. 4. A more rigid material through which the openings are formed will be surrounded by the more supple elastic material, which the user will engage. This rigid material can facilitate the repeated insertion and withdrawal of the lighting and/or writing instruments into and out of the attaching element.

FIG. 5 shows an alternate embodiment for the attaching element having ridges in the opening to further secure the writing and lighting instruments in the attaching element. Ridges such as 30 32, 34 and 36 positioned inside the openings can extend outward into the openings to further secure the writing and lighting instruments in the attaching element.

The writing instrument of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. An improved illuminated writing instrument comprising:
a writing element;
an illuminating element;
an element that attaches said writing and illuminating elements together to form an illuminated writing instrument, said attaching element having openings through which said writing element and said illuminating elements are inserted, said attaching element further comprising a ridged external surface to facilitate a better handling of the illuminated writing instrument.

2. The illuminated writing instrument as described in claim 1 wherein said attaching element is comprised of a material having supple and elastic characteristics.

3. The illuminated writing instrument as described in claim 2 wherein said attaching element has the ability to be reshaped in response to the pressure from the fingers of the user of the writing instrument.

4. The illuminated writing instrument as described in claim 3 wherein the attaching element has an initial uniformed external surface.

5. The illuminated writing instrument as described in claim 3 wherein the attaching element has an initial external surface that is contoured such that the contoured surface easily accommodates the positions of the fingers of the user of the writing instrument.

6. The illuminated writing instrument as described in claim 3 wherein said attaching element further comprises a second material immediately surrounding the openings, said second material having more rigidity than the material of the attaching element.

7. The illuminated writing instrument as described in claim 6 wherein the attaching element has an initial uniformed external surface.

8. The illuminated writing instrument as described in claim 6 wherein the attaching element has an initial external surface that is contoured such that the contoured surface easily accommodates the positions of the fingers of the user of the writing instrument.

9. The illuminated writing instrument as described in claim 1 wherein said ridged surface external surface further comprises a plurality of convex ridges.

10. The illuminated writing instrument as described in claim 1 wherein said attaching element further comprises ridges that extend outward into the openings.

11. The illuminated writing instrument as described in claim 3 wherein said attaching element further comprises a second material immediately surrounding the openings, said second material further securing the writing and illuminating elements in the attaching element.

12. The illuminated writing instrument as described in claim 1 wherein said attaching means further comprises a second material immediately surrounding the openings and ridges that extend outward into the openings, said second material and said ridges in the attaching element openings capable of further securing the writing and illuminating elements in the attaching element.
